(19) United States
(12) Patent Application Publication
(10) Pub. No.: US 2005/0068765 A1
(43) Pub. Date: Mar. 31, 2005

(54) Outdoors self sufficient uninterruptable luminaire

(76) Inventors: Juan Antonio Ertze Encinas, Laredo, TX (US); Jon Andoni Ertze Moguel, Laredo, TX (US)

Correspondence Address: JUAN ANTONIO ERTZE ENCINAS, 2528 IRWIN DRIVE, LAREDO, TX, 78045, US

(21) Appl. No.: 10/949,285

(22) Filed: Sep. 27, 2004

Related U.S. Application Data
(60) Provisional application No. 60/506,314, filed on Sep. 26, 2003.

(51) Int. Cl. F21L 4/00

(52) U.S. Cl. 362/183

(57) ABSTRACT

According to the present invention there is provided an outdoors self sufficient luminaire, weatherproof, characterized in that within the outer body are integrally housed: an array of solid state light emitting individually angle adjustable devices, a device for collecting and converting solar radiation into electrical energy, an electronic circuitry that administers the said generated electrical energy to replenish the power consumed from an accumulator during the absence of the said radiating source, an electronic circuitry that administer and control the levels of power necessary to excite individually the solid state light emitting devices in a programmable fashion, a structural integrated means for attaching the luminaire into a plurality of masts, and means for maintaining the temperature around the array of solid state light emitting devices within a predetermined range.

### CROSS-REFERENCE TO RELATED APPLICATIONS

This non-provisional utility patent is submitted as the corresponding non provisional application for the Provisional patent application No. 60/506,314. filing date: Sep. 26, 2003 with confirmation No. 9628 which applicants are Juan Antonio Ertze Encinas and Jon Andoni Ertze Moguel with the title: Outdoors Self Sufficient Uninterruptable Luminare and is presented for filing purposes within the 12-month pendency period in accordance with 35 U.C.S. 119(e).

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

1. Field of the Invention

The present invention relates to a self sufficient and uninterruptible, off the electrical grid, outdoors luminaire suitable for use to illuminate neighborhood streets, pathways and roadways, free and toll limited access highways, principal highways, secondary state, provincial and county highways, check control booths, roadside and trailer and camping parks, parking lots, rural highways, recreational docks and piers and public and entertainment areas and buildings.

2. Description of the Related Art

References Cited/Referenced By U.S. Patent Documents
U.S. Pat. No. 419,378 July, 2002 Wedell et al.
U.S. Pat. No. 3,026,394 January, 1962 Hubbell
U.S. Pat. No. 4,500,946 February, 1985 Mikola.
U.S. Pat. No. 4,509,106 April, 1985 Mayer et al.
U.S. Pat. No. 4,538,217 August, 1985 Ewing et al.
U.S. Pat. No. 4,551,793 November, 1985 Mellema.
U.S. Pat. No. 4,639,843 January, 1987 Compton.
U.S. Pat. No. 4,736,999 April, 1988 Marks et al.
U.S. Pat. No. 4,772,226 September, 1988 Schlesinger.
U.S. Pat. No. 4,791,539 December, 1988 Ewing.
U.S. Pat. No. 4,793,581 December, 1988 Bilson et al.
U.S. Pat. No. 4,796,001 January, 1989 Gostyla.
U.S. Pat. No. 4,907,139 March, 1990 Quiogue.
U.S. Pat. No. 4,937,718 June, 1990 Murray.
U.S. Pat. No. 5,134,554 July, 1992 Donato et al.
U.S. Pat. No. 5,136,493 August, 1992 Straus et al.
U.S. Pat. No. 5,243,508 September, 1993 Ewing et al.
U.S. Pat. No. 5,249,112 September, 1993 Bray.
U.S. Pat. No. 5,266,738 November, 1993 MacVoy.
U.S. Pat. No. 5,351,174 September, 1994 Ewing.
U.S. Pat. No. 5,395,246 March, 1995 Punako et al.
U.S. Pat. No. 5,535,109 July, 1996 Moore et al.

Standard column top luminaires use a discharge lamp and control apparatus, which produces light distribution in a very general and uncontrolled manner.

Lighting in general is not energy efficient as the heat generated by the lighting means is often lost to the surroundings by means of non-visible radiation.

Incandescent lamps are the lamps most familiar to homeowners; they are commonly used for the majority of residential lighting, both indoor and outdoor. Light is produced by the passage of an electrical current through a tungsten wire in an evacuated or halogen-filled glass or silica envelope. Incandescent lamps are widely available in a huge variety of lamp styles of low to moderate luminous output (mostly below 2000 lumens). They are commonly used in applications where such low outputs are needed and where the lighting is often switched off and on. Some applications take advantage of the relatively high heat production of such lamps; more than 95% of the energy used by incandescent lamps goes into the production of heat. (It has been said that incandescent lamps are really heat sources that happen to produce a little light.) Advantages include low capital cost for lamps and luminaires, wide availability, wide variety of both lamp and fixture types, lack of a warm-up period, and lack of hazardous wastes. Disadvantages include short lifetimes (most less than a few thousand hours), low efficiency (about 8-20 lumens/watt) with resultant high per-lumen energy use and life cycle cost, attraction of insects, and high heat production.

Mercury vapor lamps (sometimes called high-pressure mercury, as distinguished from fluorescent) where the first widely used high-intensity discharge lamps. Light is produced by the passage of an electric arc through a small tube filled with mercury vapor at high pressure (24 atmospheres). A ballast is required to operate the lamp, and full output is not reached for several minutes after power is applied. Though highly efficient and long-lived compared to the incandescent lighting technology they displaced after the second World War, they have many disadvantages compared to other lighting sources available today, including low luminous efficiency, poor color rendition, and high ultra-violet output. Mercury vapor lamps have now been almost completely replaced in new applications by the more efficient metal halide and high-pressure sodium lamps. Many old fixtures remain, however, and they still remain available in the homeowner market, usually in notorious and poorly shielded “barnyard” or “dusk to dawn” fixtures. They were and are so widely used in these old poorly designed fixtures that to many mercury vapor has become almost synonymous with such poor lighting. One unusual characteristic of these lamps is that they seldom “burn out,” instead fading to lower and lower outputs over years or even decades, though still consuming essentially the original amount of electrical power. Several lighting codes prohibit their use, though with mixed effectiveness. The technology is moribund, and not often specified for any extensive commercial or public outdoor lighting.

Fluorescent lamps are also seen in residential lighting, and they predominate in indoor retail and office uses, and are occasionally seen in outdoor area lighting, usually in smaller or older installations. Light is produced predominantly by fluorescent powders coated on the inside of the lamp that are activated by ultra-violet radiation produced by an electrical arc through a low-pressure (about 2/1000th atmospheric pressure) mixture of gases including mercury vapor. A current-limiting device (ballast) is required to operate these lamps, but they can typically be easily and immediately switched on and off like incandescent lamps, and they reach nearly full output almost immediately. Fluorescent lamps are also available in the so-called “compact” styles. These PL fluorescents can make highly efficient and cost-effective replacements for low-output residential lighting uses that are not too frequently cycled off and on. Outputs up to about 8000 lumens are available (about 2000 Im in “PL” styles). Advantages include low initial costs for lamps and fixtures compared with the lamp types below, low life cycle costs and high efficiency compared to incandescent (40-70 lumens/waft mean output), no warm-up period, good color rendition, and long lifetimes (10,000-20,000 hrs). Disadvantages include higher initial costs compared to incandescent lamps, large lamp size, low efficiency (compared to lamp types below) and poor output maintenance, attraction of insects, and potentially hazardous mercury waste.

Metal halide (MH) lamps are HID lamps, similar to mercury vapor lamps but with the addition of small amounts of various metallic halides, such as scandium, sodium, dysprosium, holmium and thulium iodide. Light is produced, as in the mercury vapor lamp, by the passage of an electrical arc through a small tube filled with mercury vapor and metal halides at 2-4 times atmospheric pressure. Again, a ballast is required, and full output is not reached for 2-10 minutes after power is applied. The many different varieties of metal halide lamps give a wide variety of slightly different color characteristics, though generally they are white or blue-white sources. The technology is still evolving, and new types are appearing regularly. Besides a relatively steep fall-off in intensity with time (compared to high-pressure sodium; see below), many metal halide lamps also change their color as they age. Metal halide lamps are very commonly used in commercial outdoor lighting where white light with good color rendition is required or simply desired, such as car dealer display lots, sports lighting, and service station canopies. Advantages include a wide variety of moderate to high luminous output lamps (3500-170,000 lumens mean output), high efficiency compared to incandescent and mercury vapor (45-90 lumens/watt mean), and good color rendition. Disadvantages include lower efficiency and output maintenance compared to high- and low-pressure sodium, shorter lamp lifetime compared to high-pressure sodium, color changes, ultra-violet output if not adequately filtered, and potentially hazardous mercury waste.

High-pressure sodium (HPS) lamps are currently the most widely used HID lamps for roadway and parking lot lighting, though in some areas metal halide is becoming more popular. Light is produced by passing an electric arc through a small tube filled with sodium vapor at about ¼ atmospheric pressure, and a ballast and warm-up of about 10 minutes are required. Advantages include a long lifetime, a wide variety of moderate to high luminous output lamps (2000-120,000 lumens mean output), high efficiency and good maintenance of luminous output compared to all lamp types except low-pressure sodium, moderate color rendition compared to low-pressure sodium, and wide availability and moderate cost of lamps and luminaires. Disadvantages include poorer color rendition than metal halide, fluorescent and incandescent, poorer output maintenance and efficiency than low-pressure sodium, and potentially hazardous mercury waste.

Low-pressure sodium (LPS) lamps are widely used in parts of Europe and elsewhere, and in some American cities, particularly those near active astronomical research facilities and those especially concerned about energy issues and municipal electric bills. Light is produced by the passage of an electrical arc through a tube filled with sodium vapor at about 6 millionths of atmospheric pressure. A ballast is required and 7-15 minutes are needed to reach full output.

The light produced by LPS lamps is nearly monochromatic at a wavelength near 589 nanometers. Though the eye is very sensitive to this wavelength (leading to the high efficiency of LPS), the eye cannot distinguish colors when LPS light is the only source available. Low-pressure sodium lighting is favored where energy consumption and costs are a major concern and where color discrimination is either not needed or is supplied by other lighting. Advantages include the highest luminous efficiency and lowest energy use, low glare associated with the large lamps, good visibility and low scattering, minimal effects on insects and other wildlife, and lack of hazardous mercury wastes. Disadvantages include the lack of color rendition, shorter lamp lifetime and higher lamp replacement costs compared to HPS, and large lamp size in the higher output lamps.

Neon or luminous tube lighting is a term applied to a variety of small-diameter glass-tube sources, generally used for decorative purposes and signage. Light is produced by the passage of electrical current through the gas fill, producing light with a color or spectrum characteristic of the fill gas or gases and any phosphor coating within the tubing. Luminous outputs are not typically defined per lamp, but rather per foot or per meter, and depend principally on the fill gases and diameter/current rating, but also to some extent on the manufacturer and quality. Since luminous tube lighting is used for applications taking advantage of the color variety and shape flexibility inherent in the technology and not for area lighting, it is not meaningful to compare its advantages and disadvantages to the lighting sources above. But such lighting can account for large total outputs in some cases, particularly when used for architectural outlining, and it should not be overlooked in lighting codes.

It is the object of the invention to provide an uninterruptible and self sufficient outdoors luminaire which is energy efficient and emits light with reduced glare.

### BRIEF SUMMARY OF THE INVENTION

According to the present invention there is provided an integrated outdoors self sufficient luminaire, weatherproof, characterized in that within the outer body are integrally housed: an array of solid state light emitting devices, a device for collecting and converting solar radiation into electrical energy, an electronic circuitry that administers the said generated electrical energy to replenish the power consumed from an accumulator during the absence of the said radiating source, an electronic circuitry that administer and control the levels of power necessary to excite the solid state light emitting devices in a programmable fashion, a structural integrated means for attaching the luminaries into a plurality of masts, and means for maintaining the temperature around the array of solid state light emitting devices at not higher ambient temperature.

The converted electrical energy is stored in at least one rechargeable accumulator situated in close proximity from the outer body of the luminaire. Whereby electronic circuitry is provided for controlling the charging rate of the at least one accumulator. The said at least one accumulator is covered and protected by the outer body. The close situation of the accumulator and the luminaire eliminates non necessary cable voltage drop loses enhancing luminaries efficiency.

The energy collecting unit comprises at least one solar panel which is shaped and selected from a rectangle, polygon, a pyramid, a diamond, a polyhedron and a hemi-sphere. The said solar panel comprises a framed radiation sensitive generating surface acts as the main structural element of the outer body and is positioned in an upper region of the said outer body. The said formed outer body is angle adjustable to the latitude where the luminaire is used to efficiently collect the sun radiation of the luminaire motive of this invention.

The array of solid state light emitting devices comprises a plurality of several angle adjustable solid state light emitting devices oriented at different aiming angles relative to the surface which is intended to be illuminated. The said array is contained in a weatherproof, dust sealed and temperature controlled chamber made of transparent crystal clear polycarbonate material that transmits efficiently and without degradation the emitted light to the surface to be illuminated.

The light emitted by the said array of solid state light emitting devices is transmitted by individual optical means attached to each solid state light emitters contained by the array before being directed at the at least one reflecting surface to be illuminated and are organized to produce a plurality of chromatic wavelengths to generate different colors and/or color temperatures.

The angle of the array of solid state light emitting devices respect the horizontal plane, the tilt angle or luminance angle respect to a horizontal plane is independently adjustable from the angle formed by the outer body and the horizontal plane and is used to efficiently direct the emitted light toward the illuminated surface.

An electronic circuitry is provided and housed by the outer body for controlling individually the emitted light level and/or light intensity from each and/or several groups of solid state light emitting devices comprised into the solid state light emitting array according to specific applications.

The heat regulating means comprises a heat radiating surface which becomes part of the outer body housing.

The outer body also houses at least one photo-sensitive cell. The said photo-sensitive cell acts as a light sensor that provides feedback information to electronic controlling circuitry for the activating and deactivating of the light emitting array of solid state light emitting devices during the cycle of day and night, and/or to regulate the charging and discharging rates of the at least one accumulator.

The said outer body houses, as well, at least one programmable time controller that generates the feedback information used by the electronic controlling circuitry to adjust power supplied to the solid state light emitting devices to achieve an electrical characteristic produced by the programmable light controller and associated electronic circuitry that matches pre-set characteristics known to give required lighting effects. The said known pre-set characteristics and data relating to the operational status of the outdoors luminaire are wire-less tele-transmited by a computer means.

The said elements including the outer body are structurally designed and integrally assembled to withstand as a whole wind gusts, wind speed, rain and dust storms, ultraviolet radiation from sun, vibration caused by earthquakes, sea salinity corrosion, as well as extreme cold weather situations without demerit of the light performance of the luminaries.

The outer housing geometrical shape is designed to efficiently manage the condensed water product of night and day temperature and humidity differences without impairing the light performance of the luminaire.

To perform any maintenance operations, for example the replacement of the accumulator, the luminaire outer body is not need to be disassembled nor dismounted from the mast onto which the luminaire or luminaries are attached to.

Several independent luminaries are to be attached to a one sole mast whereby the section of the said mast is polygonal or circular and even ellipsoidal.

The levels of voltages involved to power the solid state light emitters array of the luminaire allow the usage of reliable and secure electronic circuitries that eliminates the hazards of fire or any other risks at which high voltage luminaries are able to provoke.

The uninterruptible nature of the said luminaire promote the safety makes safe increases the safety close situation of the accumulator and the luminaire eliminates non necessary cable loses and avoid dangerous exposure of humans to electrical chock.

### BRIEF DESCRIPTION OF THE SEVERAL VIEWS OF THE DRAWING

For a better understanding of the present invention and to show more clearly how it may be carried into effect reference will now be made, by way of example, to the accompanying drawings in which:

FIG. 1 is a first embodiment of an outdoors self sufficient and uninterruptible luminaire according to the present invention supported on a square section street lighting mast and whereby the integrated elements are shown;

FIG. 2 illustrates the longitudinal and transverse cross sections of the first embodiment whereby the several elements which integrates the outdoors self sufficient and uninterruptible luminaire according to the present invention.

FIG. 3 is a view, on a larger scale, of the, on a larger scale and solid state light emitter devices of the outdoors luminaire shown in FIG. 1;

FIG. 4 is a schematic illustration of one of a plurality of several arrangements into which the solid state light emitter devices can be configured.

FIG. 5 is a schematic illustrates, on a larger scale, the solid state light emitter array construction elements and describes in detail the connecting means to the power distribution printed circuit board of each solid state light emitting device comprised in the solid state light emitter array chamber. Also is illustrated the method used to individually angle orient each of the comprised solid state light emitter devices at which must be aimed. The soldering process for the connecting means is performed by a programmed soldering robotized arm.

FIG. 6 illustrates the way by which the luminaire's energy collecting surface is oriented for specific latitude and obtained the most efficient orientation angle 1. This adjustment is provided by means 3, which facilitates the required swiveling action in that uses the same mast as support. The figure also illustrates the means to adjust the tilting angle 2, of the solid state light emitting array and which is independently adjusted from angle 1.

FIG. 7 illustrates the method to follow in mounting and demounting of the accumulator 5.

FIG. 8 illustrates one possible arrangement for mounting several outdoors self sufficient uninterruptible luminaries into one mast. The figure shows an arrangement of four in which the front luminaire is not shown. Is easily understood several possible arrangements are feasible as for one, two, three or four independent self sufficient uninterruptible luminaries.

FIG. 9 illustrates a transverse cross section of the self sufficient uninterruptible luminaire, motive of the present invention whereby the solar outer cover 3 is attached to the frame 1, which in turn frames as well the active energy generating solar panel element 2.

### DETAILED DESCRIPTION OF THE INVENTION OR BEST MODE FOR CARRYING OUT THE INVENTION

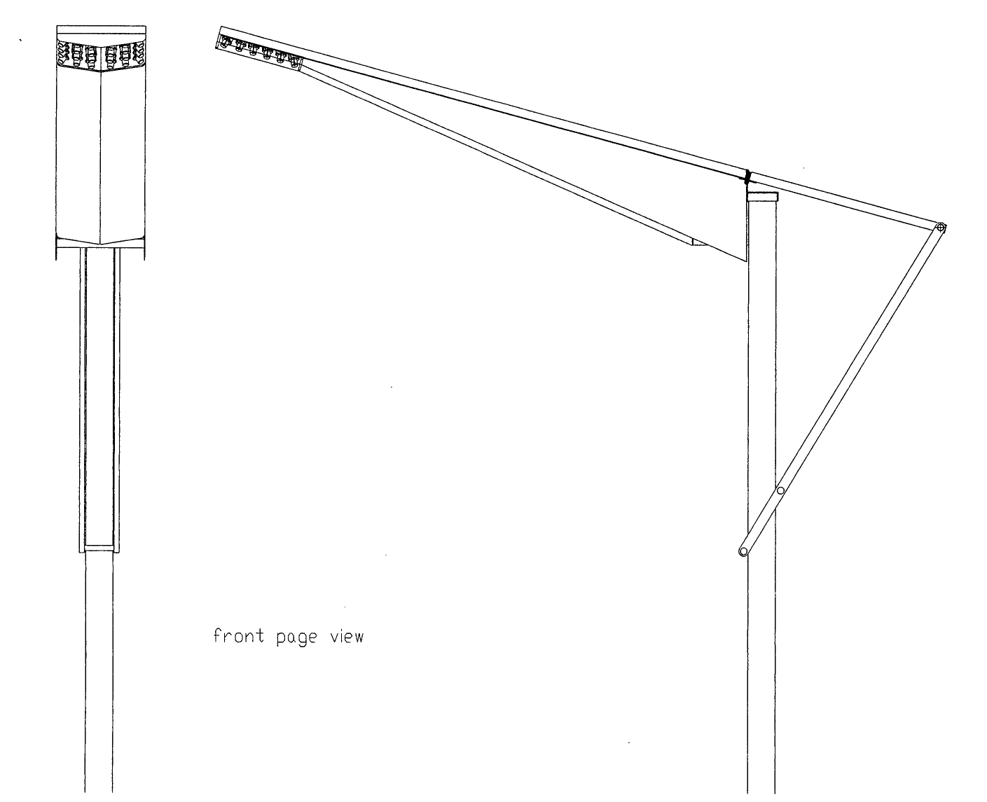

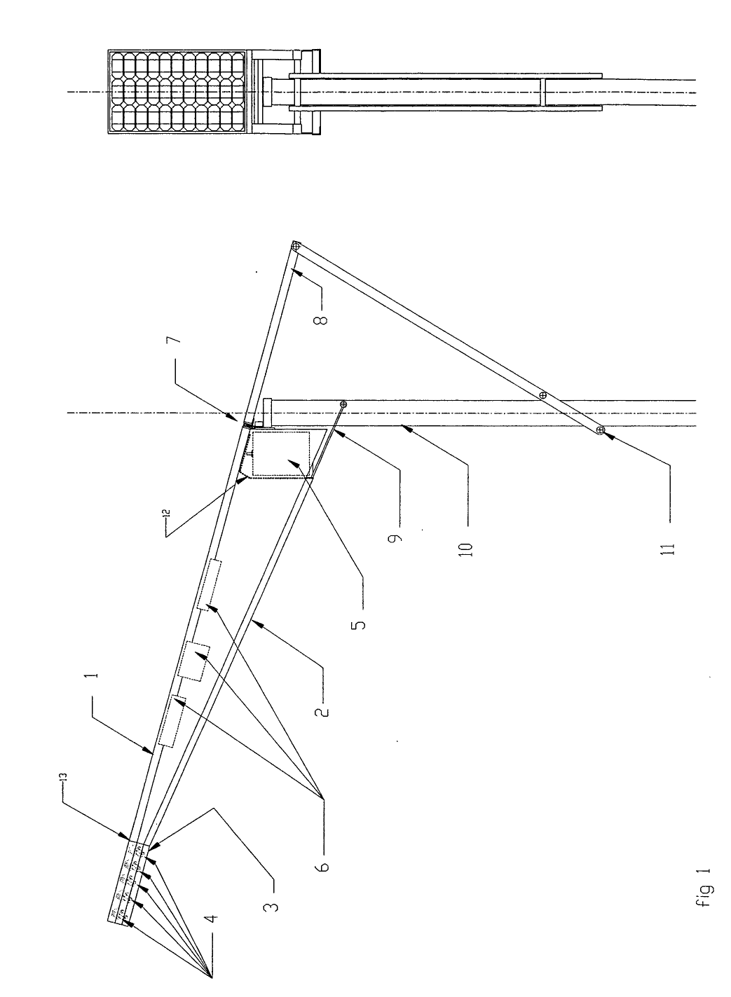

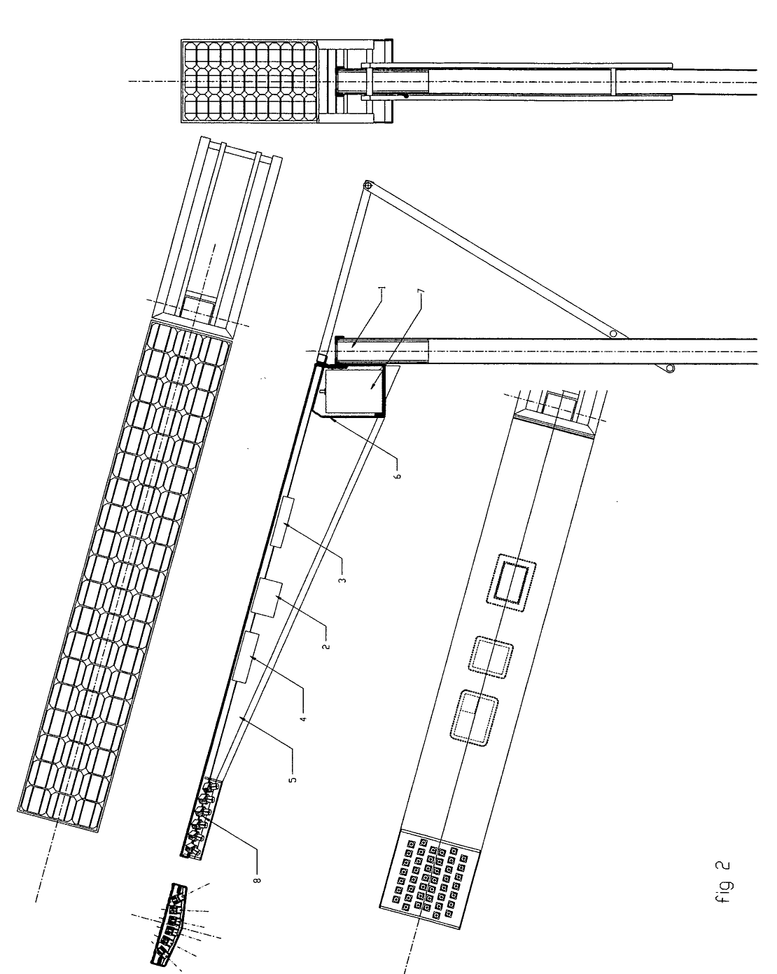

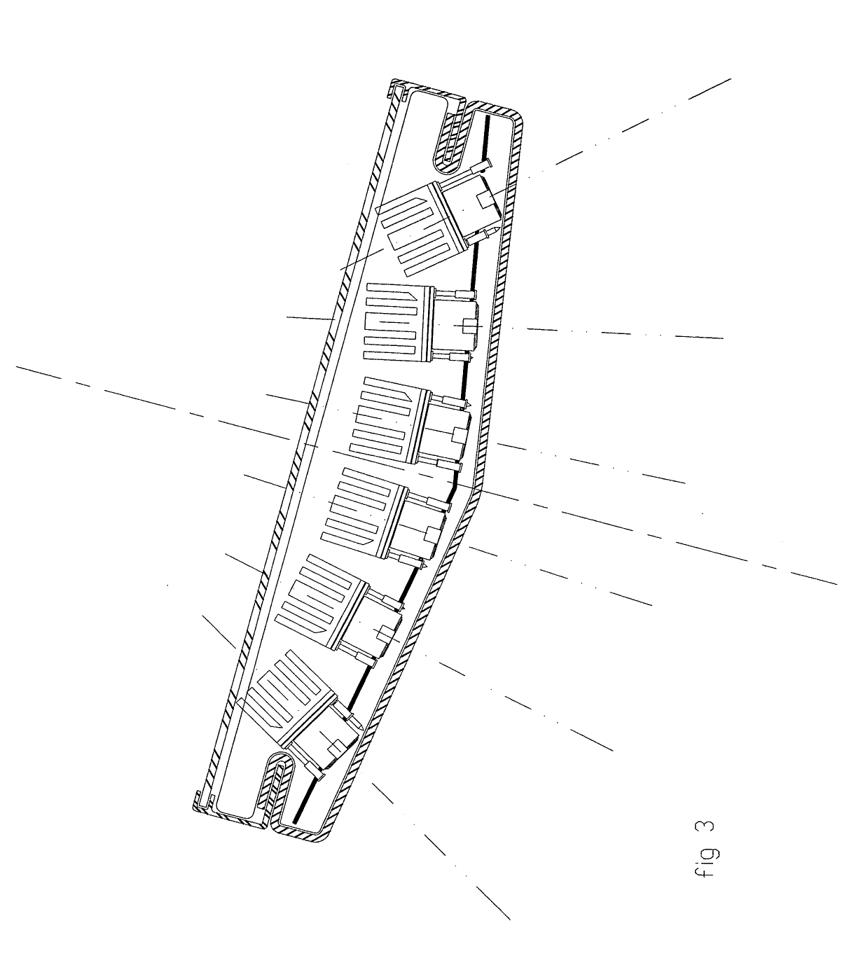

FIG. 1, FIG. 2 and FIG. 3 show a first embodiment of an outdoors luminaire attached to a square section street lighting mast 10.

The outdoors luminaire is comprised within an integral casing FIG. 1-2 and FIG. 2-1, this casing is integrated by the active element FIG. 2-1, in powering the luminaire and resolves several important aspects: as mechanical frame structure; as weather proof protective casing where wind, rain, snow, ultraviolet and infrared radiation and dust usually impairs the light performance of the luminaire itself; as temperature controlling dissipating element; and as an effective encasing for electronic circuitries involved as safety means against fire development and electric shock hazards.

The said active elements, which, comprises the luminaire encasing are:

The outer body FIG. 1-2 and FIG. 9-3, where the shape and geometry can be varied and is easily obtained by press forming or cast processes, made from a plurality of non corrosive ferrous and non ferrous sheet metal or cast materials as: stainless steel, as semi-hard bright brass or copper, aluminum; whereby the outer surface can be terminated in a plurality of finishes as mirror or B2 polished, aluminized coated, porcelain enameling chrome plated, anodizing or any other pertinent rust preventive coating, including ultraviolet resistant polycarbonate and/or any other composite laminated material.

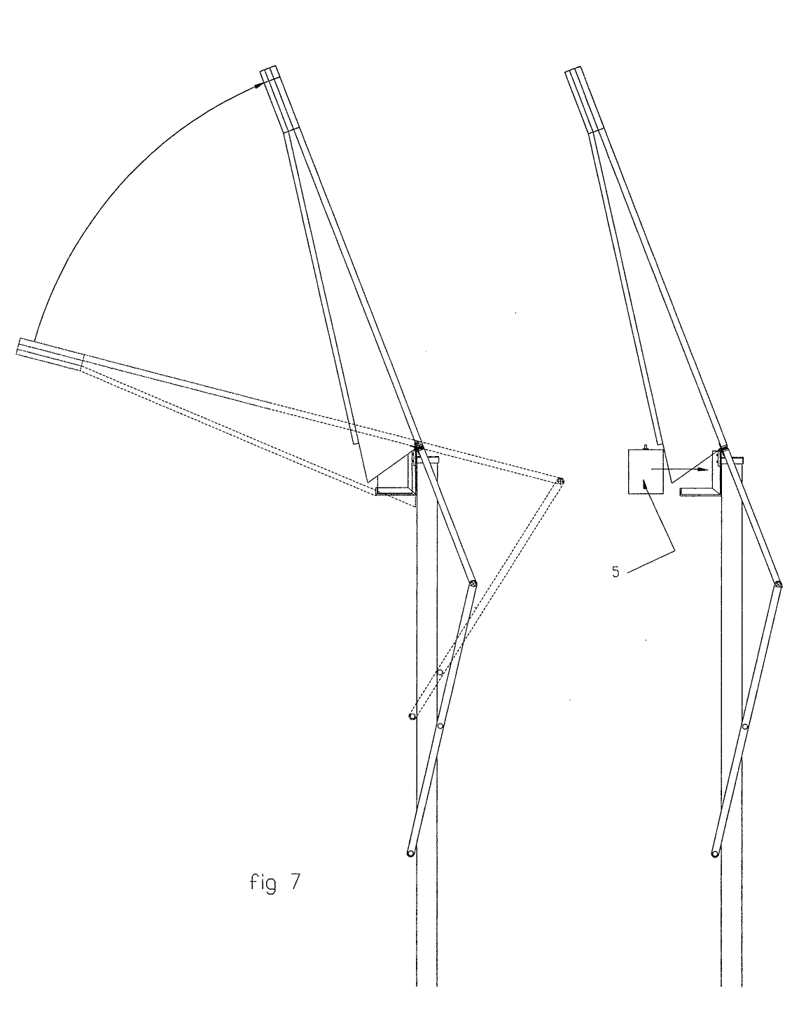

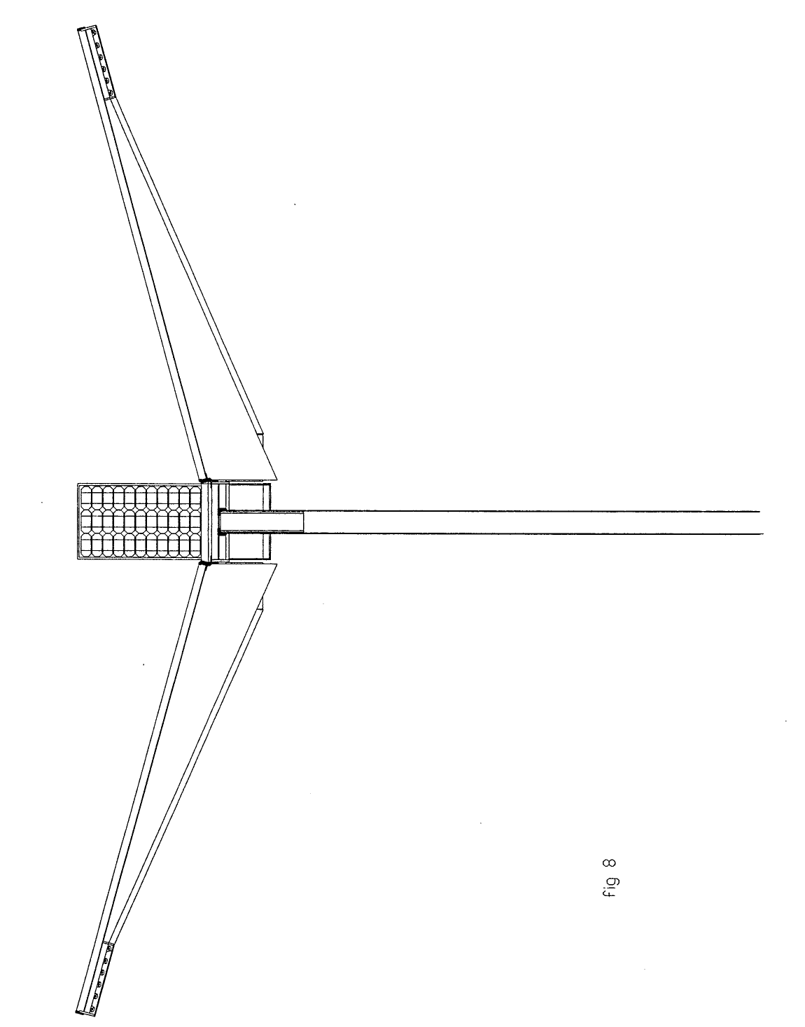

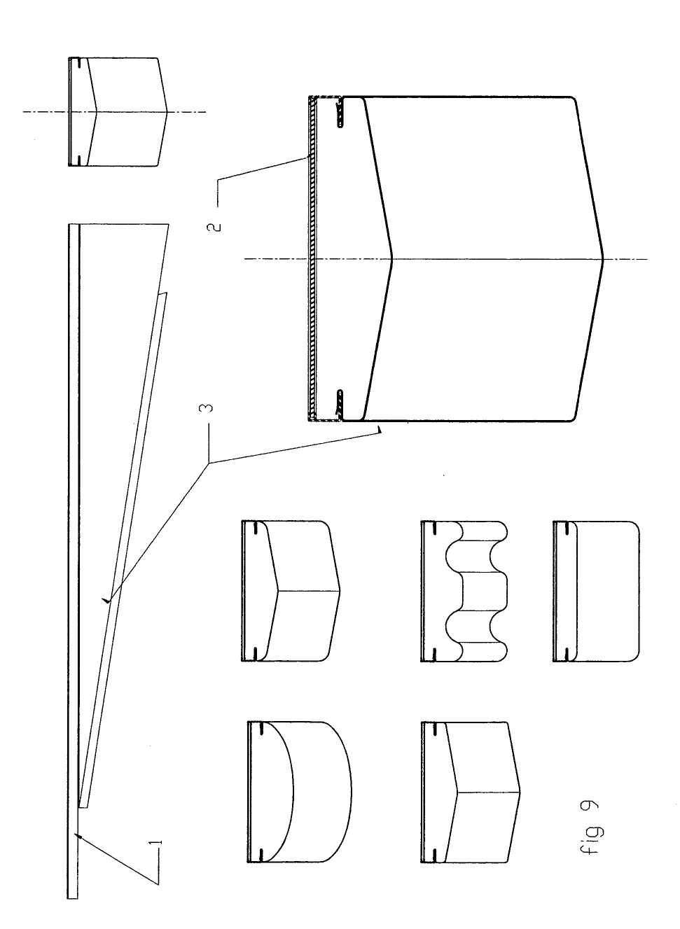

The top cover FIG. 1-1 and FIG. 9-2, contains the device for collecting and converting solar radiation into electrical energy.

Whereby the frame of the said device or panel (FIG. 9-1 and FIG. 5-8), onto where the outer body FIG. 1-2, is easily attached to the said frame by the clamping action of bended edges FIG. 9, made on the upper edge of the outer body FIG. 9-3, obtaining a tight and weather proof joint giving to the said integrated parts a very rigid closed section structure appropriate for cantilever loading of the solid state light emitter array chamber FIG. 3.

On one of the ends of said formed structure, the hinge means FIG. 1-7, is bolted on to the panel frame. On the said extreme a laminated polycarbonate formed piece FIG. 2-6, is positioned within the cavity of the said constructed encasing and acts twofold, as a weather proof sealing cover and as a compartment for the accumulator FIG. 1-5 and FIG. 2-7.

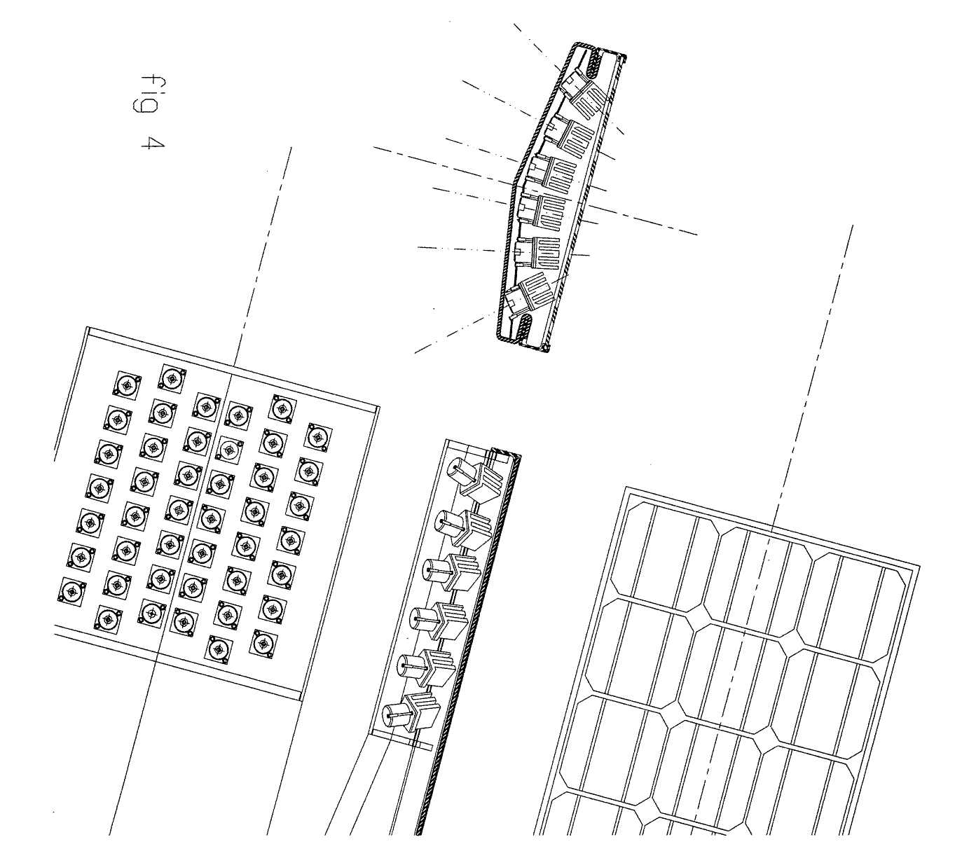

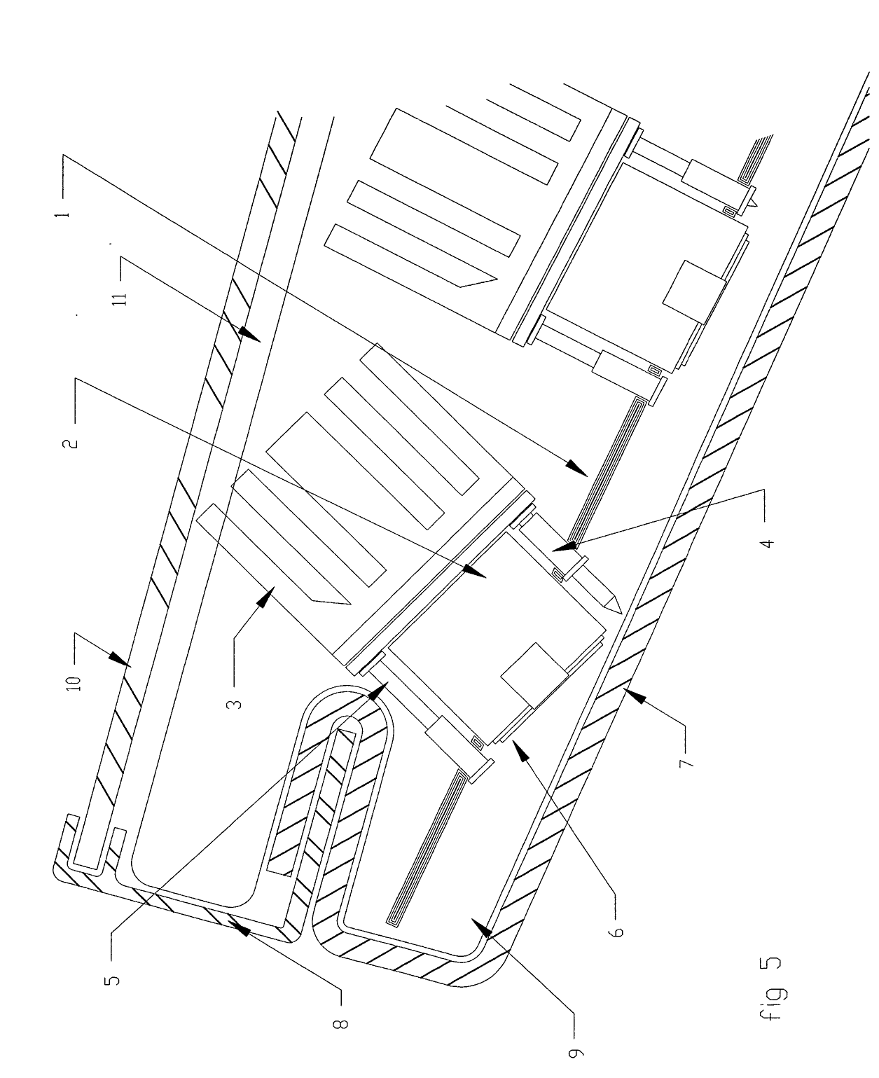

On the second end of the said formed structure is where the luminaire encased unit, the solid state light emitter array chamber (FIG. 1-3, FIG. 2-5, FIG. 3 and FIG. 4), is attached in similar manner as the outer body FIG. 5, to the frame of the said panel FIG. 5-8, by bending the top edged of the chamber cover FIG. 5-7. The transverse joint in between the outer body and the FIG. 1-13, luminaire unit is weather proof sealed by extruded elastometer means.

Within the said formed structure the electronic circuitries, are adhesive mounted on the reverse side of the said panel FIG. 2-1. These circuitries comprise the programmable unit FIG. 2-2, the replenishing regulator FIG. 2-3, and the powering luminaire circuitry FIG. 2-4.

The mast attaching means FIG. 2-1 comprises the other half hinge means, the accumulator basket support and the anchor which is slipped into the mast and onto where the luminaire is attached to. This group of elements are made of corrosion resistant materials as aluminum or stainless steel

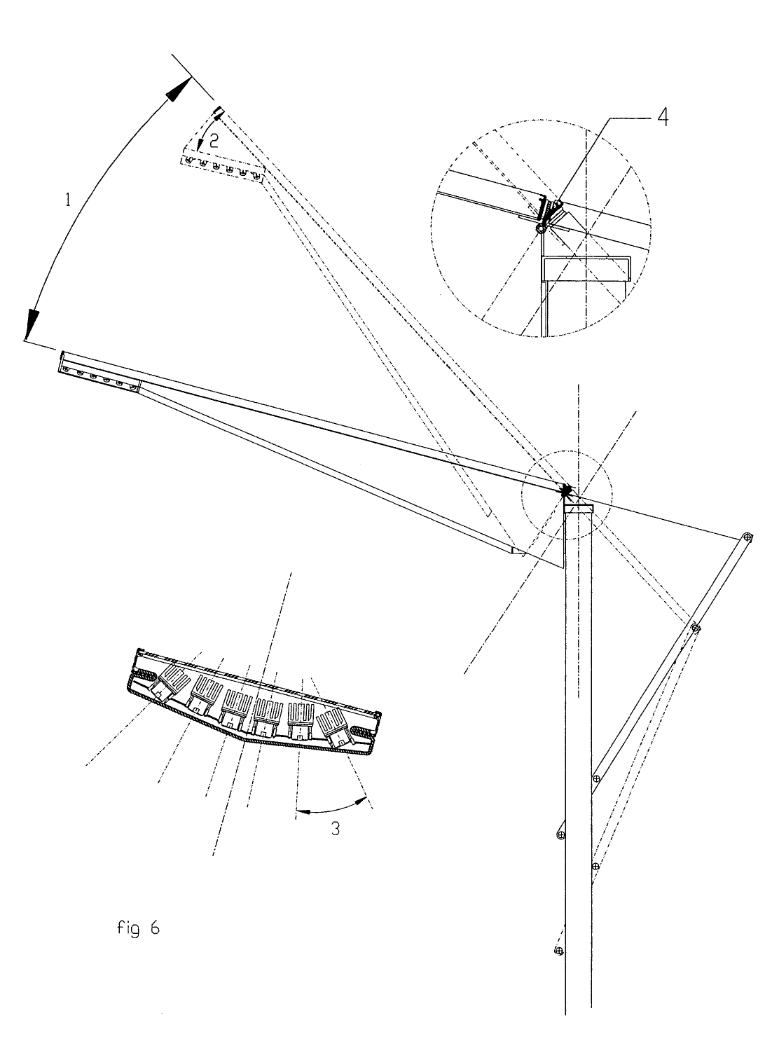

Once the said mast attaching means is slipped and positioned into the mast the said luminaire assembly is attached by slipping the hinge rod through both halves of the hinge mechanism. This arrangement allow the luminaire outer body to be rotated and position the active surface of the said device for collecting and converting solar radiation into electrical energy in the correct angle where the maximum solar radiation is obtained FIG. 6-1.

The luminaire light unit comprises the following elements: the solid state light emitter array FIG. 1-3; the tilting angle mechanism that allows the said solid state light emitting array to be adjusted FIG. 6-2, to a predetermined tilt angle; a printed circuit board FIG. 5-1, which distributes individually the electrical power for excitation of the said solid state light emitters FIG. 1-4 and FIG. 5-2, and onto where the electrical connectors means are soldered FIG. 5-4; the solid state light emitters FIG. 1-4, FIG. 5-2 which emit light with either red, green or blue wavelengths and individually contains, in one end, the application dependent optics FIG. 5-6, (collimators) and the electrical connectors FIG. 5-5, that matches the ones soldered into the printed circuit board FIG. 5-4, meanwhile in the other end one heat dissipating means is attached to FIG. 5-3; the outside cover FIG. 5-7, which acts as the attaching means to the outer body frame FIG. 5-8, and keeps the solid state light emitter array weather proof and is made of laminated transparent crystal clear polycarbonate material.

The solar panel FIG. 5-10 collects light energy entering the light gathering region FIG. 1-1, of the outer body FIG. 9-3 and converts it to electrical energy. The electrical energy is stored in the accumulator FIG. 2-7, which supply at least the power required by the array of solid state light emitting devices in the luminaire light unit FIG. 3. If the accumulator do not have sufficient charge to power the solid state light emitter array, additional power means (not shown), for example mains electricity, may be used.

The solid state light emitter array unit FIG. 3 is dust tight and thermally sealed such that it is protected against ingress of water and moisture even under heavy jet spray conditions, for example it complies with the industrial standard IP66. The chamber is also temperature controlled by means of the heat regulating means FIG. 6-3 and FIG. 6-11, which removes excess heat from within the chamber FIG. 6-9, and by high efficiency insulating material which restricts heat ingress from outside the chamber.

The solid state light emitter array contained in the chamber FIG. 3 comprises a selection of solid state light emitter devices FIG. 1-4, FIG. 2-8 and FIG. 6-2, which emit light with either red, green or blue wavelengths. By means of the electronic circuitry FIG. 2-4, the light leaving the outdoors luminaire can be controlled, for example by the customer, to be a constant single colour, to change colour or to be white light. The colour temperature of the light output can also be adjusted to suit the individual installation by means of a pre-set potentiometer or selector switch, for example set at a warm white, white or a cool white setting, or by remote DMX protocol signaling.

A light sensor, situated within the solid state light emitter array chamber, generates an electrical current which is transmitted to the electronic circuitry FIG. 2-4, to determine whether there is any reduction in light output or change in colour temperature over time, for example due to the deterioration or failure of any of the individual solid state light emitter devices, and to compensate the power to the solid state light emitter devices accordingly to maintain a stable light output over the life of the luminaire.

The change in electrical current from the light sensor triggers the electronic circuitry FIG. 2-4, to adjust the power to the appropriate red, green and blue of any of the solid state light emitter devices to achieve an electrical characteristic produced by the light sensor that matches the pre-set characteristics known to give a required lighting effect, altering the relative percentage outputs of the appropriate colour produced by the solid state light emitters devices.

The electronic circuitry is responsible for the correct operation of the solid state light emitter devices FIG. 1-4, when the photo-sensitive cell detects dusk. The circuitry FIG. 2-3, monitors and controls the charging rate of the accumulator FIG. 2-7, with energy from the solar panel FIG. 2-1, during daylight hours. The said electronic circuitry, also protects the accumulator FIG. 1-7, against overcharging during periods of excessive light, for example during the summer months, and from being excessively discharged during prolonged poor light conditions, for example in the winter.

The electronic circuitry monitors and stores data on the operational status and characteristics during the operation of the luminaire, and transmits the data to a master or central computer (not shown) for analysis and display to an operator.

The data storage is achieved by use of conventional electronics comprising slave and master units with the data being tele-transmitted by wireless technology known to a person skilled in the art.

The circuitry can also be used to regulate a secondary set of equipment, for example traffic lights, warning signs, road signs and other street furniture, in the vicinity of the mast that supports the luminaire.

As shown in FIG. 3, FIG. 4 and FIG. 5, the solid state light emitter array and its chamber are set at different tilting angles and the beams of light emitted from the solid state light emitter devices FIG. 4 are oriented over a range of angles to create a wider beam of light for emission from the luminaires A typical array of solid state light emitter devices is shown in FIG. 3.

The light from the luminaire travels through the laminated polycarbonate crystal clear cover which scatters the light in very small intensity amount but does not change the direction of the light. By passing the light through the aforesaid cover prior to illuminating the surroundings the glare of the light is reduced.

Each of the solid state light emitter devices are oriented over a range of aiming angles, creating a wider beam of light for emission from the luminaire, as shown in FIG. 5 and FIG. 6-2.

The solid state light emitters devices operate at their optimum efficiency when used at low temperatures, for example between −40 and zero degrees Celsius. The working life of the solid state light emitter array increases if the working temperature is maintained as low as possible.

The solid state light emitter array within the chamber FIG. 5-9, are mounted on a thermally conductive material which draws away heat generated by the solid state light. emitter

devices FIG. 5-3, and conducts the heat towards the outer cover formed chamber. The balance of heat is removed by convection through the external heat dissipating surfaces on the outdoors of the outer body FIG. 9-3.

For the embodiment described hereinabove it should be appreciated that the solar panel FIG. 2-1, may be of a flat form or be shaped. The shaped solar panel can selected from a variety of shapes, for example a pyramid, a diamond, a polyhedron and a hemi-sphere, or can be in a shaped form wherein the upper surface is substantially parallel with the base of the solar panel.

The invention, as claimed, is intended to provide an outdoors luminaire with nominally 100,000 hours of low energy illumination of reduced glare in an autonomous, off grid fashion. Whereby the emitted light is full program controllable in intensity, colour and aim orient able.

1. An outdoors self sufficient and uninterruptible, off the electrical distribution grid, luminaire, weatherproof, characterized in that within the outer body are integrally housed: an array of solid state light emitting devices, a device for collecting and converting solar radiation into electrical energy, an intelligent electronic circuitry that administers the said generated electrical energy to replenish the power consumed from an at least a rechargeable accumulator during the absence of the said radiating source, an electronic circuitry that administer and control the levels of power necessary to excite the solid state light emitting devices in a programmable fashion, a structural integrated means for attaching the luminaire into a plurality of masts, and means for maintaining the temperature around the array of solid state light emitting devices within a predetermined range.

2. An outdoors self sufficient and uninterruptible, off the electrical grid, outdoors luminaire suitable for use to illuminate neighborhood streets, pathways and roadways, free and toll limited access highways, principal highways, secondary state, provincial and county highways, check control booths, roadside and trailer and camping parks, parking lots, rural highways, recreational docks and piers and public and entertainment areas and buildings.

3. An outdoors luminaire as claimed in claim 1 or 2, characterized in that the at least one accumulator is covered and protected by the outer body.

4. An outdoors luminaire as claimed in any preceding claim, characterized in that the energy collecting unit comprises at least one solar panel is shaped, characterized in that the shape of the at least one solar panel is selected from a rectangle, a circle, a polygon, a pyramid, a diamond, a polyhedron and a hemisphere.

5. An outdoors luminaire, characterized in that the framed radiation sensitive generating surface acts as the main structural element of the outer body of the luminaire motive of this invention and is shaped such that an upper surface of the at least one solar panel is angle adjustable to the latitude where the luminaire is used to efficiently collect the sun radiation and positioned in an upper region of the outer body

6. An outdoors luminaire as claimed in any preceding claim, characterized in that the angle of the luminaire respect the horizontal plane, the tilt angle, is independently adjustable from the angle formed by the outer body and the horizontal plane and is used to efficiently direct the emitted light toward the illuminated surface.

7. An outdoors luminaire as claimed in any preceding claim, characterized in that the array of solid state light emitting devices is contained in a weather and dust proof and and temperature controlled sealed chamber.

8. An outdoors luminaire as claimed in any preceding claim, characterized in that the array of a plurality of light emitting devices comprises several angle adjustable solid state light emitting devices adjustable at different aiming angles relative to the surface which is intended to be illuminated.

9. An outdoors luminaire as claimed in any preceding claim, characterized in that the light emitted by the array of solid state light emitting devices is transmitted directly to the at least one reflecting surface to be illuminated.

10. An outdoors luminaire as claimed in any preceding claim, characterized in that the solid state light emitting devices are organized to produce a plurality of chromatic wavelengths and illuminated geometrical patterns.

11. An outdoors luminaire as claimed in claims 9 or 10, characterized in that electronic circuitry is provided for controlling individually the emitted light level and/or light intensities from each and/or several groups of solid state light emitting devices comprised into the solid state light emitting array according to specific applications.

12. An outdoors luminaire, characterized in that the heat regulating means comprises a heat radiating surface which becomes part of the outer body housing.

13. An outdoors luminaire, characterized in that the sensoring devices proportionate the feedback information which is used by the intelligent electronic controlling circuitry to independently adjust the power supplied to the solid state light emitting devices to achieve an electrical characteristic produced by the programmable light controller that matches pre-set characteristics known to give required lighting effects.

14. An outdoors self sufficient luminaire, characterized in that the iluminance angle respect to a horizontal plane is adjustable.

15. An outdoors self sufficient luminaires characterized in that an electronic circuitry is provided to, wire-less tele-transmit, to and from the luminaire, data related to the operational status of the outdoors luminaire, as well as image signals to a computer for analysis and control.

16. An outdoors luminaire as claimed in any preceding claim, characterized in that several independent luminaries are to be attached to a one sole mast whereby the section of the said mast is polygonal or circular and even ellipsoidal and where all the elements and components are integrated and made from non-corrosive materials and are structurally designed and assemble to withstand as a whole, wind gusts, wind speed, rain storms, ultraviolet radiation from sun, vibration caused by earthquakes, sea salinity corrosion proof, as well as extreme cold weather situations without demerit the light performance of the luminaire.

17. An outdoors self sufficient luminaire, characterized in that to perform any maintenance operations, for example the replacement of the accumulator, the luminaire outer body is not need to be disassembled nor dismounted from the mast onto which the luminaire or luminaries are attached to and where the levels of voltages involved in powering the solid state light emitters array of the luminaire allow the usage of reliable and secure electronic circuitries and eliminates the hazards of fire or any other risks which high voltage luminaries are able to provoke and eliminates non necessary cable loses and aisolate humans from dangerous electrical chock.

18. An outdoors self sufficient luminaire, characterized in that the close situation of the accumulator and the luminaire reduces cable voltage drops loses enhancing luminaire efficiency.

19. An outdoors luminaire characterized in that refractors and or reflectors devices are not required.

20. An outdoors luminaire characterized in that ballasts, capacitors, igniters, coils, transformers or any other electrical AC devices are not required.
